(19) United States
(12) Patent Application Publication
(10) Pub. No.: US 2025/0365375 A1
(43) Pub. Date: Nov. 27, 2025

(54) IMAGE FORMING DEVICE ACCESS METHOD, DEVICE, APPARATUS AND STORAGE MEDIUM

(71) Applicant: Beijing Pantum Information Technology Ltd., Beijing (CN)

(72) Inventors: Zhuo YAO, Beijing (CN); Yongjiu JIANG, Beijing (CN)

(21) Appl. No.: 19/209,606

(22) Filed: May 15, 2025

(30) Foreign Application Priority Data
May 27, 2024 (CN) 202410667173.2

(51) Int. Cl. H04N 1/00; H04L 41/12

(52) U.S. Cl. CPC H04N 1/00204; H04L 41/12; H04N 1/00037; H04N 1/00082; H04N 2201/0036; H04N 2201/0039

(57) ABSTRACT

An image forming device accessing method includes acquiring access network information of a target image forming device; determining whether the target image forming device and a mobile terminal are in a same local area network (LAN) according to the access network information; when the target image forming device and the mobile terminal are in the same LAN, accessing the target image forming device according to LAN configuration information of the target image forming device in a pre-configured device list of the mobile terminal; and when the target image forming device and the mobile terminal are not in the same LAN, accessing the target image forming device according to a mapping network address corresponding to the target image forming device in the pre-configured device list of the mobile terminal, where the pre-configured device list includes the LAN configuration information of the target image forming device and the mapping network address.

### CROSS-REFERENCE TO RELATED DISCLOSURE

This application claims priority of Chinese Patent Application No. 202410667173.2 filed on May 27, 2024, the entire content of which is hereby incorporated by reference.

### TECHNICAL FIELD

The application relates to the field of printing technology, and in particular to an image forming device access method, device, apparatus and storage medium.

### BACKGROUND

With the widespread application of Internet technology, printers, as commonly used office apparatus, usually need to be connected to a wide area network (WAN) and/or a local area network (LAN) for networking. It is particularly important for users to access printers conveniently, quickly, and accurately in different network environments.

In the existing technologies, when a user accesses a printer through a terminal, s/he can establish communication with a printer in a LAN through a WAN, or connect the terminal with the printer in the same LAN. However, when the network environment of the terminal changes, the printer cannot be accessed automatically, affecting the user experience.

### SUMMARY

The present disclosure provides an image forming device access method, device, apparatus and storage medium, so as to improve user experience.

In one aspect, the present disclosure provides an access method for an image forming device, which is applied to a mobile terminal. The access method includes: acquiring access network information of a target image forming device; determining whether the target image forming device and the mobile terminal are in a same LAN according to the access network information; when the target image forming device and the mobile terminal are in the same LAN, accessing the target image forming device according to LAN configuration information of the target image forming device in a pre-configured device list of the mobile terminal; and when the target image forming device and the mobile terminal are not in the same LAN, accessing the target image forming device according to a mapping network address corresponding to the target image forming device in the pre-configured device list of the mobile terminal, where the pre-configured device list includes the LAN configuration information of the target image forming device and the mapping network address.

In another aspect, the present disclosure provides an electronic device, and the electronic device includes one or more processors and a memory containing a computer program that, when being executed, causes the one or more processors to perform: acquiring access network information of a target image forming device; determining whether the target image forming device and the mobile terminal are in a same LAN according to the access network information; when the target image forming device and the mobile terminal are in the same LAN, accessing the target image forming device according to LAN configuration information of the target image forming device in a pre-configured device list of the mobile terminal; and when the target image forming device and the mobile terminal are not in the same LAN, accessing the target image forming device according to a mapping network address corresponding to the target image forming device in the pre-configured device list of the mobile terminal, where the pre-configured device list includes the LAN configuration information of the target image forming device and the mapping network address.

In another aspect, the present disclosure provides a non-transitory computer-readable storage medium containing a computer program that, when being executed, causes at least one processor to perform: acquiring access network information of a target image forming device; determining whether the target image forming device and the mobile terminal are in a same LAN according to the access network information; when the target image forming device and the mobile terminal are in the same LAN, accessing the target image forming device according to LAN configuration information of the target image forming device in a pre-configured device list of the mobile terminal; and when the target image forming device and the mobile terminal are not in the same LAN, accessing the target image forming device according to a mapping network address corresponding to the target image forming device in the pre-configured device list of the mobile terminal, where the pre-configured device list includes the LAN configuration information of the target image forming device and the mapping network address.

Other features of the present disclosure and advantages thereof will become apparent from the following detailed description of exemplary embodiments of the present disclosure with reference to the accompanying drawings.

### BRIEF DESCRIPTION OF THE DRAWINGS

The accompanying drawings, which are incorporated in and constitute a part of this specification, illustrate embodiments consistent with the present disclosure and, together with the descriptions, serve to explain the principles of the present disclosure.

FIG. 1 is a schematic diagram of an application scenario of an access method for an image forming device, in accordance with an embodiment of the present disclosure;

FIG. 2 is a flow chart of a method for accessing an image forming device, in accordance with an embodiment of the present disclosure;

FIG. 3 is a business scenario block diagram of a method for accessing an image forming device, in accordance with an embodiment of the present disclosure;

FIG. 4 is a business scenario block diagram of a method for accessing an image forming device, according to another embodiment of the present disclosure;

FIG. 5 is a schematic structural diagram of an access device for an image forming device, in accordance with an embodiment of the present disclosure; and

FIG. 6 is a schematic structural diagram of an electronic device, in accordance with an embodiment of the present disclosure.

The above drawings show some embodiments of the present disclosure, which will be described in more detail later. These drawings and text descriptions are not intended to limit the scope of the present disclosure in any way, but to illustrate the concept of the present disclosure to those skilled in the art by referring to specific embodiments.

### DETAILED DESCRIPTION

Exemplary embodiments will be described in detail hereinafter with reference to the accompanying drawings. When the following description refers to the drawings, the same numbers in different drawings represent the same or similar elements unless otherwise indicated. The exemplary embodiments described in the following do not represent all embodiments consistent with the present disclosure. Instead, they are merely examples of devices and methods consistent with some aspects of the present disclosure as detailed in the appended claims.

In the existing technologies, after a mobile terminal searches for an image forming device such as a printer in a LAN, the mobile terminal will use the LAN configuration information of the searched printer to overwrite the printer configuration information manually added in a pre-configured device list on the mobile terminal. The printer configuration information manually added in the pre-configured device list includes the mapping network address of the printer in the WAN. If the user's mobile terminal switches to another network (not the LAN where the printer is located, such as the WAN), that is, the user's network environment changes, this results in the inability of the mobile terminal to use the LAN configuration information to access the printer, and the mapping network address of the printer needs to be manually added to the pre-configured device list on the mobile terminal again, which seriously affects the user experience.

To address the above technical problems, the present disclosure provides an image forming device access method, device, apparatus, and storage medium, which simultaneously saves the LAN configuration information and mapping network address of a target image forming device in a pre-configured device list on a mobile terminal, and automatically selects the corresponding configuration to access the target image forming device according to the network environment in which the mobile terminal and the target image forming device are located. This ensures that the target image forming device can still be accessed after the network environment in which the user's mobile terminal is located changes, thereby improving the user experience.

The technical solution of the present disclosure and how the technical solution of the present disclosure solves the aforementioned technical problems are described in detail below with specific embodiments. The following specific embodiments may be combined with each other, and the same or similar concepts or processes may not be repeated in some embodiments. The embodiments of the present disclosure will be described below in conjunction with the accompanying drawings.

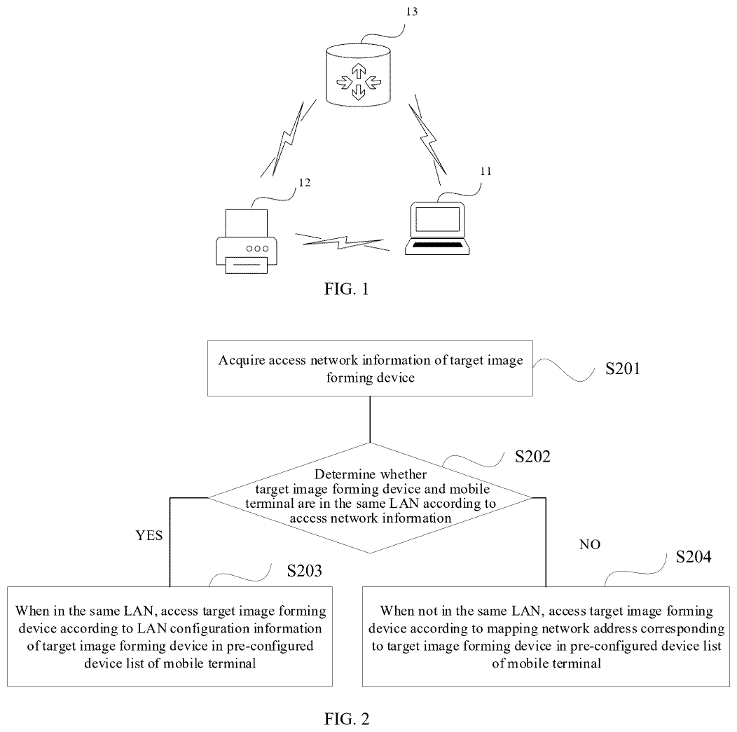

FIG. 1 is a schematic diagram of an application scenario of an access method for an image forming device, in accordance with an embodiment of the present disclosure. Referring to FIG. 1, the application scenario includes a mobile terminal 11, an image forming device 12, and a routing device 13, where a port forwarding rule may be configured on the routing device 13. The rule includes that the IP address of the image forming device 12 in the LAN is mapped to the WAN IP address, the user manually adds the WAN IP address to the mobile terminal 11 for storage, and accesses the image forming device 12 in the LAN through the WAN IP address. For example, when the mobile terminal 11 and the image forming device 12 are in the same LAN, the mobile terminal 11 adds the LAN configuration information obtained for the image forming device 12 to the terminal device 11, while retaining the original WAN IP address of the image forming device 12 on the mobile terminal 11, and then uses the LAN configuration information to access the image forming device 12. When the mobile terminal 11 switches to a LAN where the image forming device 12 is not located, for example, the mobile terminal 11 is in a WAN and the image forming device 12 is in a LAN, the original WAN IP address of the image forming device 12 on the mobile terminal 11 is used to access the image forming device 12.

It should be noted that the mobile terminal 11 may be a wearable device, a mobile phone, a computer, a notebook or a personal digital assistant (PDA) and the like, the image forming device 12 may be a printer, a scanner and the like, and there is no limit on the number of image forming devices 12.

In the following, in combination with the application scenario of FIG. 1, the access method of the image forming device is described with reference to FIG. 2, and the access method of the image forming device is executed by the mobile terminal 11 in FIG. 1. It should be noted that the above application scenario is merely to facilitate understanding of the spirit and principle of the present disclosure, and the embodiments of the present disclosure are not limited to the application scenario shown in FIG. 1.

FIG. 2 is a flow chart of a method for accessing an image forming device, in accordance with an embodiment of the present disclosure. The method for accessing an image forming device is applied to a mobile terminal, in accordance with an embodiment of the present disclosure. As shown in FIG. 2, the method for accessing an image forming device includes the following steps.

S201: Acquire access network information of a target image forming device.

The access network information may include the host name, serial number, model, MAC address, LAN IP address and other information of the target image forming device, where the LAN IP address is used to access the target image forming device, and the target image forming device performs operations such as printing files.

For example, a printing application, such as Mopria software, is installed on a mobile terminal, and a method for accessing an image forming device is integrated into the printing application. Relevant function buttons, such as a search button, may be configured on the printing application interface. The search button is used to search for a target image forming device in the network where the mobile terminal is located. In some embodiments, a service location protocol (SLP) is deployed on both the mobile terminal and the image forming device. Clicking the search button may trigger the use of the SLP protocol to search for access network information of the image forming device in the network environment.

Optionally, the mobile terminal may also obtain the access network information of the target image forming device through a server that manages the image forming device. The server may communicate with the mobile terminal, and the mobile terminal sends a query request to the server, and the server returns the relevant attribute information of the image forming device (which can be understood as the access network information) to the mobile terminal. For example, there is a server for managing image forming devices in the network, and the server may uniformly manage all image forming devices within the managed network and their access network information.

It should be noted that the embodiments of the present disclosure do not limit the methods for obtaining the access network information of the target image forming device, and a suitable method may be selected according to actual needs.

S202: Determine whether the target image forming device and the mobile terminal are in the same LAN according to the access network information.

For example, this may be determined based on the LAN IP address in the access network information. After the mobile terminal device obtains the LAN IP address of the target image forming device, the mobile terminal device may compare the LAN IP address of the target image forming device with its own IP address to determine whether they have the same network segment. For example, if the IP address of the mobile terminal device is 192.168.31.122 and the LAN IP address of the target image forming device is 192.168.1.146, then the outcome of the comparison is that the target image forming device and the mobile terminal do not have the same network segment, that is, the target image forming device and the mobile terminal are not in the same LAN. If the LAN IP address of the target image forming device is 192.168.31.146, then the outcome of the comparison is that the target image forming device and the mobile terminal have the same network segment, that is, they are in the same LAN.

In another example, after obtaining the LAN IP address of the target image forming device, the mobile terminal device may also use a ping operation to determine whether it is in the same LAN as the target image forming device. If it can be pinged, it means the mobile terminal device is in the same LAN as the target image forming device. If it cannot be pinged, it means the mobile terminal device is not in the same LAN as the target image forming device.

Optionally, if the SLP protocol is applied to automatically search for the target image forming device, according to the principle of the SLP protocol, when the mobile terminal can obtain the access network information of the target image forming device in the network where it is located, it means that the mobile terminal and the target image forming device are in the same LAN. When the mobile terminal cannot obtain the access network information of the target image forming device in the network where it is located, it means that the mobile terminal and the target image forming device are not in the same LAN.

In the embodiments of the present disclosure, there is no limitation on the specific methods of determining whether the target image forming device and the mobile terminal are in the same LAN based on the access network information.

S203: When the two devices are in the same LAN, access the target image forming device according to the LAN configuration information of the target image forming device in the pre-configured device list of the mobile terminal.

The LAN configuration information includes the device identifier information and the LAN IP address of the target image forming device. The device identifier information includes at least one of a serial number and a host name, and may also include a MAC address and the like.

For example, in an actual application scenario, when a mobile terminal is connected to the LAN where the target image forming device is located, and the user wants to use the target image forming device to print files or pictures, the mobile terminal will automatically select the LAN configuration information corresponding to the target image forming device from the configuration information stored in the pre-configured device list to access the target image forming device, that is, send a print instruction or data to the LAN IP address. Alternatively, the user may manually select the LAN IP address of the target image forming device in the pre-configured device list to print files or pictures.

S204: When the two devices are not in the same LAN, access the target image forming device according to a mapping network address corresponding to the target image forming device in the pre-configured device list of the mobile terminal.

The pre-configured device list includes the LAN configuration information and the mapping network address of the target image forming device.

The pre-configured device list is stored on the mobile terminal, and the configuration information of the image forming device is uniformly managed through the pre-configured device list. In some embodiments, the pre-configured device list may also store information such as the online/offline status and model of the image forming device, that is, the image forming device configuration information is not limited to including the mapping network address, host name, online/offline status, serial number, and model corresponding to the image forming device. Here, the mapping network address can be understood as having a certain correspondence with the LAN IP address of the image forming device. The mapping network address may be a WAN IP address (corresponding to the scenario where the mobile terminal is in the WAN and the image forming device is in the LAN), or it may be the LAN IP address where the terminal is located (corresponding to the scenario where the mobile terminal and the image forming device are in two different LANs).

For example, the mobile terminal switches to a LAN where the target image forming device is not located, which may be a WAN or another LAN. The mobile terminal automatically selects to use the mapping network address to access the target image forming device, that is, sends a print instruction or data to the mapping network address. Since the mapping network address has a certain correspondence with the LAN IP address of the target image forming device, the mapping network address will forward the print instruction or data to the LAN IP address of the target image forming device.

In the embodiments of the present disclosure, when the mobile terminal and the target image forming device are located in the same LAN, the target image forming device is accessed using the LAN configuration information. When the mobile terminal and the target image forming device are located in different LANs, the target image forming device is accessed using a mapping network address. This then allows to automatically select a method for accessing the target image forming device according to the network environment, thereby ensuring that the target image forming device can still be accessed after the network environment in which the user's mobile terminal is located changes, which improves the user experience.

In the embodiments of the present disclosure, the target image forming device is accessed by using the LAN configuration information, so as to realize automatic selection of access to the target image forming device according to the network environment, thereby ensuring that the target image forming device can still be accessed after the network environment of the user's mobile terminal changes, thereby improving the user experience.

Further, before accessing the target image forming device according to the LAN configuration information of the target image forming device in the pre-configured device list of the mobile terminal, the following steps are included.

S301: Determine whether the pre-configured device list includes LAN configuration information of the target image forming device.

In this step, whether the LAN configuration information of the target image forming device exists in the pre-configured device list may be determined by information with a unique identifier. For example, the serial number of the image forming device, the serial number and model, the host name, or the host name and model, etc., may all uniquely identify the target image forming device. The embodiments of the present disclosure do not specifically limit the basis for determining whether the LAN configuration information of the target image forming device exists in the pre-configured device list.

S302: When the pre-configuration list does not include the LAN configuration information of the target image forming device, add the access network information as the LAN configuration information to the pre-configuration device list.

In this step, if the target image forming device already exists in the pre-configured device list, that is, the pre-configured device list contains the same host name or serial number as the target image forming device, when the access network information is added to the pre-configured device list as the LAN configuration information, the mobile terminal side will also retain the mapping network address for the target image forming device manually added by the user. For example, the pre-configured device list contains an image forming device with a host name of: xx, model: yy, serial number: zz, IP1: 192.168.31.146, and IP2: 172.29.1.10, where IP1 refers to the LAN IP address and IP2 refers to the mapping network address.

Compared with the existing technologies in which, when adding LAN configuration information to the pre-configuration list, the mapping network address of the target image forming device in the pre-configuration list is directly overwritten with the access network information (i.e., the LAN configuration information), in the embodiments of the present disclosure, when the user switches to a LAN that is not the same as the target image forming device, the user does not need to manually add the mapping network address again. The embodiments of the present disclosure are more user-friendly and provide a better user experience.

Based on the above embodiments, before accessing the target image forming device according to the LAN configuration information of the target image forming device in the pre-configured device list of the mobile terminal, the method further includes the following steps.

S401: Determine whether the pre-configured device list includes LAN configuration information of the target image forming device.

This step is implemented in the same way as S301 and will not be described again here.

S402: When the pre-configuration list includes the LAN configuration information of the target image forming device, determine whether the LAN network address of the target image forming device has been changed according to the access network information and the LAN configuration information.

For example, after the mobile terminal obtains the access network information of the target image forming device, the mobile terminal parses the LAN IP address from the access network information, and compares the LAN IP address with the LAN configuration information corresponding to the target image forming device stored in the pre-configuration list. If they are inconsistent, it is determined that the LAN network address has changed. If they are consistent, it is determined that the LAN network address has not changed. For example, the LAN IP address in the access network information of the target image forming device is 192.168.31.146, and the LAN IP address in the LAN configuration information corresponding to the target image forming device already in the pre-configuration list is 192.168.31.151, then it is determined that the LAN network address has changed.

S403: When the LAN address of the target image forming device is changed, update the LAN configuration information corresponding to the target image forming device in the pre-configured device list according to the access network information.

It can be understood that in the pre-configured device list, for the same image forming device, only one valid LAN configuration information is saved. When the LAN network address of the target image forming device is changed, the LAN network address in the LAN configuration information corresponding to the target image forming device in the pre-configured device list is updated to the LAN network address in the access network information.

In the embodiments of the present disclosure, when it is determined that the LAN network address of the target image forming device has changed, the LAN configuration information corresponding to the target image forming device in the pre-configured device list is updated in a timely manner to ensure that the LAN configuration information in the pre-configured device list is accurate and effective, thereby further improving the user experience.

In some embodiments, the method for accessing an image forming device further includes: automatically searching for a target image forming device according to a network discovery protocol to obtain LAN configuration information of the target image forming device.

Here, the network discovery protocol may allow the discovery of service resources in the LAN. For example, the network discovery protocol may be the service location protocol SLP or Bonjour protocol, or other network discovery protocols with equivalent effects, which are not limited in the disclosure. The SLP protocol enables computers or other devices to search for service resources in the LAN without pre-setting, such as automatically discovering printers, scanners, computing resources, home electronic devices, etc., in the LAN.

The Bonjour protocol is a zero-configuration network protocol based on the domain name system (DNS). The Bonjour protocol is mainly used to automatically discover and configure devices and services in a LAN. For example, the Bonjour protocol may automatically discover and connect to a printer in a LAN without manually inputting the printer's IP address.

In some embodiments, the SLP protocol is deployed on both the mobile terminal and the target image forming device. The mobile terminal acts as a client, and the target image forming device acts as a server. The client broadcasts the required service type in the network. After receiving the broadcast message from the client, the server replies with its own attribute information to the client. The server and the client cooperate with each other. For example, the service type is a printing service, and the target image forming device is a printer. The attribute information includes host name, online/offline status, serial number, model, LAN network address and other information. In the disclosed embodiments, the attribute information can be understood as LAN configuration information.

The embodiments of the present disclosure utilize the working principle of the network discovery protocol to automatically search for a target image forming device in a LAN, thereby obtaining the LAN configuration information of the target image forming device.

Based on the above embodiments, in one embodiment, the method for accessing an image forming device further includes: before acquiring access network information of the target image forming device, configuring a mapping network address corresponding to the target image forming device in the pre-configured device list.

For example, in the Mopria software on a mobile terminal, the user may manually add the mapping network address corresponding to the target image forming device to the pre-configured device list, and may also add other information such as the host name, online/offline status, serial number, model, etc., of the image forming device to the pre-configured device list.

In another example, after adding the mapping network address corresponding to the target image forming device to the pre-configured device list, clicking the Finish button may trigger the mobile terminal to access the target image forming device through the mapping network address, thereby obtaining other information about the target image forming device, such as host name, online/offline status, serial number, model and other information, and storing it in the pre-configured device list.

It should be noted that if the routing device is connected to multiple image forming devices in a LAN, the information of multiple image forming devices is added to the pre-configured device list. The multiple image forming devices have the same mapping network address, but at least have different host names and serial numbers. For example, when accessing the target image forming device, it may be uniquely identified by the host name and/or serial number, mapping network address, etc.

In some embodiments, a correspondence between the mapping network address and the LAN address of the image forming device may be pre-established and stored. Correspondingly, the access method of the image forming device may further include:

Step 1-1: Acquire configuration information for the routing device, where the configuration information includes a LAN address and a port of a target image forming device, the routing device is connected to the target image forming device, and the routing device is connected to a mobile terminal.

For example, the mobile terminal is in a WAN, and the target image forming device is in a LAN. The mobile terminal and the target image forming device cannot communicate directly. The WAN port of the routing device is connected to the mobile terminal, and the LAN port of the routing device is connected to the target image forming device. A unique public network IP is assigned to the WAN port in the WAN. The user may log in to the WEB management page of the routing device on the mobile terminal and configure the routing device on the management page, for example, create a port forwarding rule on the WEB management page, add the LAN address and port of the target image forming device to the port forwarding rule name, and click the OK button. The mobile terminal may obtain the configuration information for the routing device and trigger the configuration of the routing device.

Step 1-2: Configure the routing device according to the configuration information to associate the LAN address and the port of the target image forming device with the mapping network address.

For example, when the OK button is clicked, the port forwarding rule takes effect, mapping the LAN network address and the port of the target image forming device to the WAN port, that is, establishing a correspondence between the LAN network address and the port of the target image forming device and the mapping network address on the routing device.

It should be noted that in actual application scenarios, a mobile terminal may be connected to multiple routing devices, and one routing device may be connected to multiple image forming devices in a LAN. The LAN addresses and ports of multiple image forming devices may be configured and saved simultaneously on one routing device.

In the embodiments of the present disclosure, by flexibly configuring the LAN network address and port of the target image forming device on the routing device, the mobile terminal may access the target image forming device through the IP address (public IP) of the WAN port in the WAN, which is simple to operate, flexible to configure, and provides a good user experience.

Furthermore, the aforementioned determining whether the pre-configured device list includes the LAN configuration information of the target image forming device may include: determining whether the pre-configured device list includes the LAN configuration information of the target image forming device according to the unique identifier information of the target image forming device.

The unique identifier information may uniquely determine the target image forming device among multiple image forming devices. For example, the host name and serial number are unique. In the disclosed embodiments, it may be determined whether the target image forming device exists in the pre-configured device list based on the host name, the serial number, or the host name and the serial number. Since the LAN configuration information includes at least the host name, the serial number and the LAN network address, it may be determined whether the pre-configured device list contains the LAN configuration information of the target image forming device.

Based on the above embodiments, the access method of the image forming device is further described in detail through some specific embodiments.

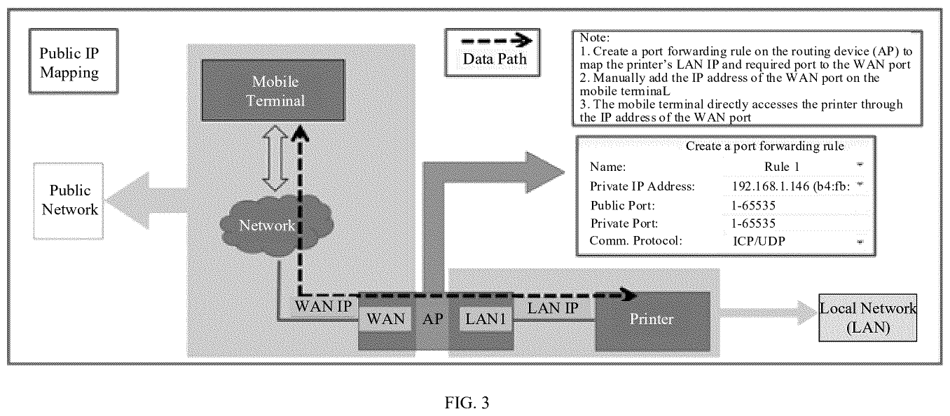

FIG. 3 is a business scenario block diagram of a method for accessing an image forming device, in accordance with an embodiment of the present disclosure. As shown in FIG. 3, the business scenario is that a mobile terminal accesses a printer in another network (public network), and the printer is in a LAN. The method for accessing an image forming device specifically includes the following steps:

1. Create a port forwarding rule on the routing device (AP) to map the printer's LAN IP and required port to the WAN port.

For example, create a port forwarding rule named Rule 1, set the private IP address to the IP address of the printer in the LAN, such as 192.168.1.146, and set the public port to the port corresponding to the business function provided by the printer, usually a range segment, such as 1-65535.

2. Manually add the IP address of the WAN port on the mobile terminal.

For example, the IP address assigned to the WAN port is 192.168.31.224, and the IP of the mobile terminal in the public network is 192.168.31.112. Manually add 192.168.31.224 to the pre-configured device list on the mobile terminal. The IP address assigned to the WAN port is the mapping network address of the printer.

3. The mobile terminal directly accesses the printer through the IP address of the WAN port.

The mobile terminal in the public network accesses the mapping network address 192.168.31.224 of the printer, which may forward data or print instructions to the port of the LAN printer.

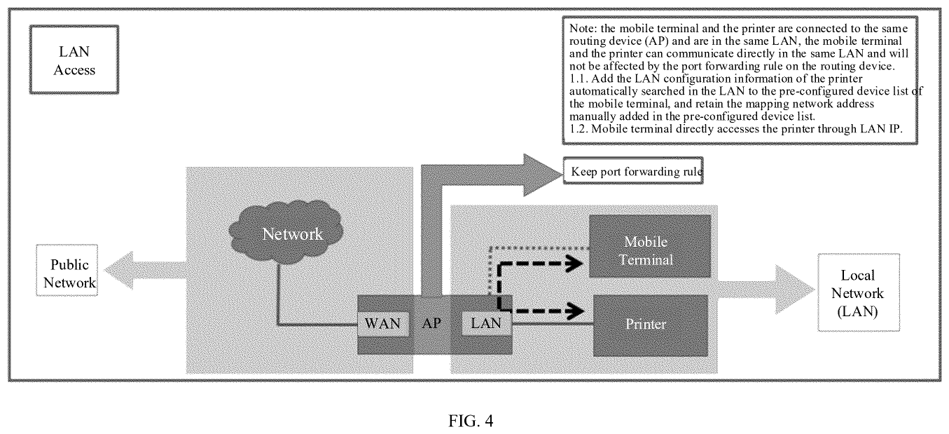

FIG. 4 is a business scenario block diagram of an access method for an image forming device, in accordance with another embodiment of the present disclosure. As shown in FIG. 4, the business scenario is that a mobile terminal searches for and accesses a printer in a LAN. Since the mobile terminal and the printer are connected to the same routing device (AP) and are in the same LAN, the mobile terminal and the printer may communicate directly in the same LAN and will not be affected by the port forwarding rule(s) on the routing device. Accordingly, the access method for the image forming device specifically includes the following steps.

1.1. Add the LAN configuration information of the printer automatically searched in the LAN to the pre-configured device list of the mobile terminal, and retain the mapping network address manually added in the pre-configured device list.

For example, when the Mopria software is opened on the mobile terminal, it will automatically search for the printer in the LAN and add the LAN configuration information to the pre-configured device list, while retaining the manually added mapping network address in the pre-configured device list (the IP address 192.168.31.224 assigned to the WAN port).

1.2. Mobile terminal directly accesses the printer through LAN IP.

For example, if the IP address of the mobile terminal is 192.168.1.112 and the LAN IP address of the printer is 192.168.1.146, the mobile terminal may directly access the printer through 192.168.1.146.

The following is an example of the access device of the image forming device of the present disclosure, which may be configured to execute the method embodiments of the present disclosure. For details not disclosed in the device embodiments of the image forming device of the present disclosure, refer to the method embodiments of the present disclosure.

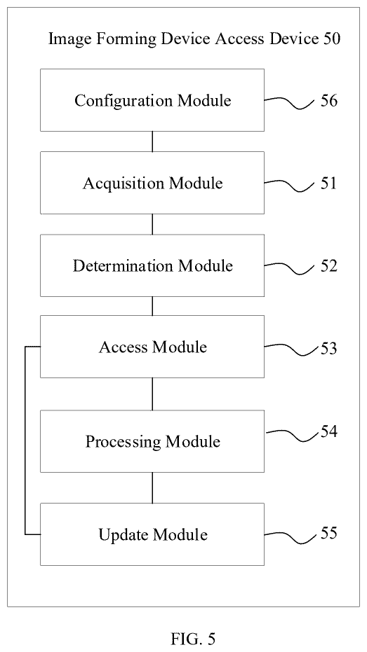

FIG. 5 is a schematic structural diagram of an access device of an image forming device, in accordance with an embodiment of the present disclosure. As shown in FIG. 5, the access device 50 of the image forming device includes: an acquisition module 51, a determination module 52 and an access module 53.

The acquisition module 51 is configured to acquire access network information of a target image forming device.

The determination module 52 is configured to determine whether the target image forming device and the mobile terminal are in the same LAN according to the access network information.

The access module 53 is configured to access the target image forming device according to the LAN configuration information of the target image forming device in the pre-configured device list of the mobile terminal when the target image forming device and the mobile terminal are in the same LAN; and to access the target image forming device according to the mapping network address corresponding to the target image forming device in the pre-configured device list of the mobile terminal when the two are not in the same LAN. The pre-configured device list includes the LAN configuration information and the mapping network address of the target image forming device.

In some embodiments, the access device 50 of the image forming device also includes a processing module 54, which is configured to: before accessing the target image forming device based on the LAN configuration information of the target image forming device in the pre-configured device list of the mobile terminal, determine whether the pre-configured device list contains the LAN configuration information of the target image forming device; when the pre-configured list does not contain the LAN configuration information of the target image forming device, add the access network information as the LAN configuration information to the pre-configured device list.

In some embodiments, the access device 50 of the image forming device also includes an update module 55, and the update module 55 is configured to: before accessing the target image forming device according to the LAN configuration information of the target image forming device in the pre-configured device list of the mobile terminal, determine whether the pre-configured device list contains the LAN configuration information of the target image forming device; when the pre-configured list contains the LAN configuration information of the target image forming device, determine whether the LAN network address of the target image forming device has changed according to the access network information and the LAN configuration information; when the LAN network address of the target image forming device has changed, update the LAN configuration information corresponding to the target image forming device in the pre-configured device list according to the access network information.

In some embodiments, the acquisition module 51 is specifically configured to: automatically search for the target image forming device according to a network discovery protocol to obtain the access network information of the target image forming device.

In some embodiments, the image forming device access device 50 further includes a configuration module 56, where the configuration module 56 is used to configure a mapping network address corresponding to the target image forming device in the pre-configured device list before acquiring the access network information of the target image forming device.

In some embodiments, the processing module 54 is also configured to: obtain configuration information for the routing device, the configuration information including the LAN network address and port of the target image forming device, the routing device being connected to the target image forming device, and the routing device being connected to the mobile terminal; and configure the routing device according to the configuration information to associate the LAN network address and port of the target image forming device to the mapping network address.

In some embodiments, the processing module 54 may be further configured to: determine whether the pre-configured device list includes the LAN configuration information of the target image forming device according to the unique identifier information of the target image forming device.

The access device of the image forming device in the disclosed embodiments may execute the technical solution shown in the above method embodiments, and its implementation principle and beneficial effects are similar, which will not be described again here.

It should be noted that the division of the various modules of the above device is only a division of logical functions. In actual applications, these modules may be fully or partially integrated into one physical entity, or may be physically separated. And these modules may all be implemented in the form of software called by processing elements, or these modules may also be implemented in the form of hardware. In some embodiments, some modules may also be implemented in the form of software called by processing elements, while other modules may be implemented in the form of hardware. For example, the processing module may be a separately established processing element, or may be integrated in a chip of the above device. In addition, the processing module may also be stored in the memory of the above device in the form of program code, and called and executed by a processing element of the above device. The implementation of other modules is similar. In addition, these modules may be fully or partially integrated together, or may be implemented independently. The processing element here may be an integrated circuit with signal processing capabilities. In the implementation process, each step of the above method or each module above may be completed by an integrated logic circuit of hardware in the processor element or instructions in the form of software.

For example, the above modules may be one or more integrated circuits configured to implement the above methods, such as one or more application specific integrated circuits (ASICs), or one or more microprocessors (DSPs), or one or more field programmable gate arrays (FPGAs). For another example, when a module is implemented in the form of a processing element calling program code, the processing element may be a general-purpose processor, such as a central processing unit (CPU) or another processor that may call the program code. For another example, these modules may be integrated together and implemented in the form of a system-on-a-chip (SOC).

In the above embodiments, the various modules may be implemented in whole or in part by software, hardware, firmware, or any combination thereof. When implemented using software, these modules may be implemented in whole or in part in the form of a computer program product. The computer program product includes one or more computer instructions. When loading and executing computer instructions on a computer, the process or function according to the embodiments of the present disclosure is generated in whole or in part. The computer may be a general-purpose computer, a special-purpose computer, a computer network, or other programmable devices. The computer instructions may be stored in a computer-readable storage medium, or transmitted from one computer-readable storage medium to another computer-readable storage medium. For example, the computer instructions may be transmitted from a website, computer, server, or data center by wired (e.g., coaxial cable, optical fiber, digital subscriber line (DSL), etc.) or wireless (e.g., infrared, wireless, microwave, etc.) mode to another website site, computer, server or data center. The computer-readable storage medium may be any available medium that a computer may access or a data storage device such as a server or data center that includes one or more available media integrated. The available media may be magnetic media (e.g., floppy disks, hard disks, magnetic tapes), optical media (e.g., digital video discs (DVDs)), or semiconductor media (e.g., solid state disks (SSDs)).

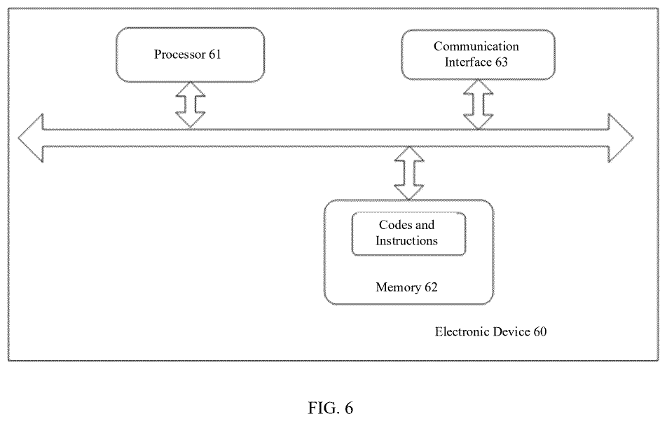

FIG. 6 is a schematic structural diagram of an electronic device, in accordance with an embodiment of the present disclosure. As shown in FIG. 6, the electronic device 60 includes: at least one processor 61 and a memory 62. The memory 62 is configured to store instructions, and the processor 61 is configured to call the instructions in the memory to execute the steps provided in the above method embodiments. The specific implementation methods and technical effects are similar and will not be repeated here.

Optionally, the memory 62 may be independent or integrated with the processor 61.

The memory 62 may include a random access memory (RAM), and may also include a non-volatile memory, such as at least one disk memory.

The processor 61 may be a general-purpose processor, including a central processing unit, a network processor (NP), a DSP, an ASIC, an FPGA, or other programmable logic devices, discrete gate or transistor logic devices, or discrete hardware components.

Optionally, the electronic device 60 may further include a communication interface 63. In some embodiments, if the communication interface 63, the memory 62, and the processor 61 are implemented independently, or the communication interface 63, the memory 62 and the processor 61 may be interconnected through a bus and communicate with each other. The system bus may be a peripheral component interconnect (PCI) bus or an extended industry standard architecture (EISA) bus, etc. The system bus may be divided into an address bus, a data bus, a control bus, etc., but it does not mean that there is only one bus or one type of bus.

Optionally, in some embodiments, if the communication interface 63, the memory 62 and the processor 61 are integrated on a chip, and the communication interface 63, the memory 62 and the processor 61 may complete communication through an internal interface.

The implementation principle and technical effects of the electronic device provided in the disclosed embodiments may be found in the aforementioned embodiments and will not be described in detail here.

The embodiments of the present disclosure also provide a computer-readable storage medium, in which computer execution instructions are stored. When the computer execution instructions are executed, the instructions are configured to implement the steps in the above method embodiments. The specific implementation methods and technical effects are similar and will not be repeated here.

The aforementioned computer-readable storage medium may be implemented by any type of volatile or non-volatile storage device or a combination thereof, such as static random access memory (SRAM), electrically erasable programmable read only memory (EEPROM), erasable programmable read only memory (EPROM), programmable read only memory (PROM), read only memory (ROM), magnetic storage, flash memory, magnetic disk or optical disk. The readable storage medium may be any available medium that may be accessed by a general or special-purpose computer.

The present disclosure also provides a program product, which includes computer-executable instructions. When the computer-executable instructions are executed, the steps in the above method embodiments are implemented. The specific implementation methods and technical effects are similar and will not be repeated here.

The image forming device access method, device, apparatus and storage medium provided by the present disclosure determine whether the target image forming device and the mobile terminal are in the same LAN. If the target image forming device and the mobile terminal are in the same LAN, the target image forming device is accessed according to the LAN configuration information of the target image forming device in the pre-configured device list of the mobile terminal. If the target image forming device and the mobile terminal are not in the same LAN, the target image forming device is accessed according to the mapping network address corresponding to the target image forming device in the pre-configured device list of the mobile terminal. The pre-configured device list includes the LAN configuration information and the mapping network address of the target image forming device. The above process allows the automatic selection of a method for accessing the target image forming device according to the network environment, satisfying the user's requirements for correctly accessing the target image forming device in a variety of network environments, thereby improving the user experience.

Those skilled in the art will readily appreciate other embodiments of the present disclosure after considering the specification and practicing the disclosure disclosed herein. The present disclosure is intended to cover any modification, use or adaptation of the present disclosure, which follows the general principles of the present disclosure and includes common knowledge or customary techniques in the art that are not disclosed in the present disclosure. The specification and embodiments are intended to be exemplary only, and the true scope and spirit of the present disclosure are indicated by the following claims.

It should be understood that the present disclosure is not limited to the precise structures that have been described above and shown in the drawings and that various modifications and changes may be made without departing from the scope thereof. The scope of the present disclosure is further defined through the appended claims.

What is claimed is:

1. A method for accessing an image forming device and applied to a mobile terminal, and the method comprising:
acquiring access network information of a target image forming device;
determining whether the target image forming device and the mobile terminal are in a same local area network (LAN) according to the access network information;
when the target image forming device and the mobile terminal are in the same LAN, accessing the target image forming device according to LAN configuration information of the target image forming device in a pre-configured device list of the mobile terminal; and
when the target image forming device and the mobile terminal are not in the same LAN, accessing the target image forming device according to a mapping network address corresponding to the target image forming device in the pre-configured device list of the mobile terminal,
wherein the pre-configured device list includes the LAN configuration information of the target image forming device and the mapping network address.

2. The method according to claim 1, wherein, before accessing the target image forming device according to the LAN configuration information of the target image forming device in the pre-configured device list of the mobile terminal, the method further comprises:
determining whether the pre-configured device list includes the LAN configuration information of the target image forming device; and
when the pre-configuration list does not include the LAN configuration information of the target image forming device, adding the access network information to the pre-configuration device list as the LAN configuration information.

3. The method according to claim 1, wherein, before accessing the target image forming device according to the LAN configuration information of the target image forming device in the pre-configured device list of the mobile terminal, the method further comprises:
determining whether the pre-configured device list includes the LAN configuration information of the target image forming device;
when the pre-configuration list includes the LAN configuration information of the target image forming device, determining whether a LAN address of the target image forming device has been changed according to the access network information and the LAN configuration information; and
when the LAN address of the target image forming device is changed, updating the LAN configuration information of the target image forming device in the pre-configured device list according to the access network information.

4. The method according to claim 1, wherein obtaining access network information of a target image forming device comprises:
obtaining the access network information of the target image forming device according to a network discovery protocol.

5. The method according to claim 1, wherein, before acquiring the access network information of the target image forming device, the method further comprises:
configuring the mapping network address corresponding to the target image forming device in the pre-configured device list.

6. The method according to claim 1, further comprising:
acquiring configuration information for a routing device, the configuration information including a LAN address and a port of the target image forming device, the routing device being connected to the target image forming device, and the routing device being connected to the mobile terminal; and
configuring the routing device according to the configuration information to associate the LAN address and the port of the target image forming device with the mapping network address.

7. The method according to claim 2, wherein determining whether the pre-configured device list includes the LAN configuration information of the target image forming device comprises:
determining whether the pre-configured device list includes the LAN configuration information of the target image forming device according to unique identifier information of the target image forming device.

8. An electronic device, comprising one or more processors and a memory containing a computer program that, when being executed, causes the one or more processors to perform:
acquiring access network information of a target image forming device;
determining whether the target image forming device and a mobile terminal are in a same LAN according to the access network information;
when the target image forming device and the mobile terminal are in the same LAN, accessing the target image forming device according to LAN configuration information of the target image forming device in a pre-configured device list of the mobile terminal; and
when the target image forming device and the mobile terminal are not in the same LAN, accessing the target image forming device according to a mapping network address corresponding to the target image forming device in the pre-configured device list of the mobile terminal,
wherein the pre-configured device list includes the LAN configuration information of the target image forming device and the mapping network address.

9. The electronic device according to claim 8, wherein the one or more processors are further caused to perform:
determining whether the pre-configured device list includes the LAN configuration information of the target image forming device; and
when the pre-configuration list does not include the LAN configuration information of the target image forming device, adding the access network information to the pre-configuration device list as the LAN configuration information.

10. The electronic device according to claim 8, wherein the one or more processors are further caused to perform:
determining whether the pre-configured device list includes the LAN configuration information of the target image forming device;
when the pre-configuration list includes the LAN configuration information of the target image forming device, determining whether a LAN address of the target image forming device has been changed according to the access network information and the LAN configuration information; and
when the LAN address of the target image forming device is changed, updating the LAN configuration information of the target image forming device in the pre-configured device list according to the access network information.

11. The electronic device according to claim 8, wherein the one or more processors are further caused to perform:
obtaining the access network information of the target image forming device according to a network discovery protocol.

12. The electronic device according to claim 8, wherein the one or more processors are further caused to perform:
configuring the mapping network address corresponding to the target image forming device in the pre-configured device list.

13. The electronic device according to claim 8, wherein the one or more processors are further caused to perform:
acquiring configuration information for a routing device, the configuration information including a LAN address and a port of the target image forming device, the routing device being connected to the target image forming device, and the routing device being connected to the mobile terminal; and
configuring the routing device according to the configuration information to associate the LAN address and the port of the target image forming device with the mapping network address.

14. The electronic device according to claim 9, wherein the one or more processors are further caused to perform:
determining whether the pre-configured device list includes the LAN configuration information of the target image forming device according to unique identifier information of the target image forming device.

15. A non-transitory computer readable storage medium containing a computer program that, when being executed, causes at least one processor to perform:
acquiring access network information of a target image forming device;
determining whether the target image forming device and a mobile terminal are in a same LAN according to the access network information;
when the target image forming device and the mobile terminal are in the same LAN, accessing the target image forming device according to LAN configuration information of the target image forming device in a pre-configured device list of the mobile terminal; and
when the target image forming device and the mobile terminal are not in the same LAN, accessing the target image forming device according to a mapping network address corresponding to the target image forming device in the pre-configured device list of the mobile terminal,
wherein the pre-configured device list includes the LAN configuration information of the target image forming device and the mapping network address.

16. The non-transitory computer-readable storage medium according to claim 15, wherein the at least one processor is further caused to perform:
determining whether the pre-configured device list includes the LAN configuration information of the target image forming device; and
when the pre-configuration list does not include the LAN configuration information of the target image forming device, adding the access network information to the pre-configuration device list as the LAN configuration information.

17. The non-transitory computer-readable storage medium according to claim 15, wherein the at least one processor is further caused to perform:
determining whether the pre-configured device list includes the LAN configuration information of the target image forming device;
when the pre-configuration list includes the LAN configuration information of the target image forming device, determining whether a LAN address of the target image forming device has been changed according to the access network information and the LAN configuration information; and
when the LAN address of the target image forming device is changed, updating the LAN configuration information of the target image forming device in the pre-configured device list according to the access network information.

18. The non-transitory computer-readable storage medium according to claim 15, wherein the at least one processor is further caused to perform:
obtaining the access network information of the target image forming device according to a network discovery protocol.

19. The non-transitory computer-readable storage medium according to claim 15, wherein the at least one processor is further caused to perform:
configuring the mapping network address corresponding to the target image forming device in the pre-configured device list.

20. The non-transitory computer-readable storage medium according to claim 15, wherein the at least one processor is further caused to perform:
acquiring configuration information for a routing device, the configuration information including a LAN address and a port of the target image forming device, the routing device being connected to the target image forming device, and the routing device being connected to the mobile terminal; and
configuring the routing device according to the configuration information to associate the LAN address and the port of the target image forming device with the mapping network address.
